(19) United States
(12) Patent Application Publication
(10) Pub. No.: US 2006/0268734 A1
(43) Pub. Date: Nov. 30, 2006

(54) Asymmetric data rate system and method

(75) Inventors: Ghobad Heidari-Bateni, San Diego, CA (US); Stanislaw Czaja, Cardiff, CA (US)

Correspondence Address: MORRISON & FOERSTER LLP, 12531 HIGH BLUFF DRIVE, SUITE 100, SAN DIEGO, CA, 92130-2040, US

(73) Assignee: Olympus Communication Technology of America, Inc.

(21) Appl. No.: 11/376,004

(22) Filed: Mar. 15, 2006

Related U.S. Application Data
(60) Provisional application No. 60/672,606, filed on Apr. 19, 2005.
(60) Provisional application No. 60/674,797, filed on Apr. 25, 2005.

(51) Int. Cl. H04L 12/26

(52) U.S. Cl. 370/252

(57) ABSTRACT

Described herein are systems, methods, computer program products, and combinations and sub-combinations thereof for enabling a network device to establish transmit and receive data rates independently from one another. According to one aspect of the invention, the transmit and receive data rates can be decoupled by designating the rate capability of each device for at least one of either its transmitter or receiver. For example, in one embodiment, the rate capability of network device receivers can be designated, and the devices' transmit rate capabilities not announced. The transmit rate capability is known to the transmitting device, while the receive rate capability of the receiving device is announced through its beacon or other scheduling window. Hence, the transmitting device can determine at what data rate to transmit based on the information it receives from the other devices.

### CROSS REFERENCE To RELATED APPLICATIONS

This application claims the benefit of priority under 35 U.S.C. § 119(e) to U.S. provisional application Ser. No. 60/674,797, filed on Apr. 25, 2005, and claims the benefit of priority under 35 U.S.C. § 119(e) to U.S. provisional application Ser. No. 60/672,606, filed Apr. 19, 2005, the entirety of which is incorporated by reference herein.

### FIELD OF THE INVENTION

The present invention relates generally to communication devices, and more particularly to a system and method for decoupling communication rates across a communication channel.

### BACKGROUND OF THE INVENTION

With the many continued advancements in communications technology, more and more devices are being introduced in both the consumer and commercial sectors with advanced communications capabilities. Additionally, advances in processing power and low-power consumption technologies, as well as advances in data coding techniques have led to the proliferation of wired and wireless communications capabilities on a more widespread basis.

For example, communication networks, both wired and wireless, are now commonplace in many home and office environments. Such networks allow various heretofore independent devices to share data and other information to enhance productivity or simply to improve their convenience to the user. One such communication network that is gaining widespread popularity is an exemplary implementation of a wireless network such as that specified by the WiMedia-MBOA (Multiband OFDM Alliance). Other exemplary networks include the Bluetooth® communications network and various IEEE standards-based networks such as 802.11 and 802.16 communications networks, to name a few.

Architects of these and other networks, and indeed communications channels in general, have long struggled with the challenge of managing multiple communications across a limited channel. For example, in some environments, more than one device may share a common carrier channel and thus run the risk of encountering a communication conflict between the one or more devices on the channel.

Over the years, network architects have come up with various solutions to arbitrate disputes or otherwise delegate bandwidth among the various communicating devices, or clients, on the network. Schemes used in well known network configurations such as token rings, Ethernet, and other configurations have been developed to allow sharing of the available bandwidth. In addition to these schemes, other techniques have been employed, including for example CDMA (code division multiple access) and TDMA (time division multiple access) for cellular networks.

FDM (Frequency Division Multiplexing) is another technology that enables multiple devices to transmit their signals simultaneously over a communication channel in a wired or wireless setting. The devices' respective signals travel within their designated frequency band (carrier), onto which the data (text, voice, video, or other data.) is modulated. With adequate separation in frequency band spacing, multiple devices can simultaneously communicate across the same communication channel (network or point-to-point).

Orthogonal FDM (OFDM) spread spectrum systems distribute the data over a plurality of carriers that are spaced apart at precise frequencies. The spacing is chosen so as to provide orthogonality among the carriers. Thus, a receiver's demodulator recovers the modulated data with little interference from the other carrier signals. The benefits of OFDM are high spectral efficiency, resiliency to RF interference, and lower multi-path distortion or inter symbol interference (ISI). OFDM systems can be combined with other techniques (such as time-division multiplexing) to allow sharing of the individual carriers by multiple devices as well, thus adding another dimension of multiplexing capability.

However, even with various multiplexing schemes available to network and other communication channel designers, there can still be inefficiencies in bandwidth allocation due to various factors. For example, many network and communication channels specify symmetric data rates for two way communications. That is, a given network device is implemented such that it conducts transmit operations at the same data rate at which it conducts receive operations. As just one example of this, the currently specified versions of the MB-OFDM (WiMedia) system define device physical layer capabilities in terms of symmetrical support of all data rates. In this definition, both transmit and receive data rate capabilities are associated with a single bit in the physical layer (PHY) capability bitmap field. As the current definition of this standard consists of eight data rates, and entire byte (octet) is utilized to define the device capability. Such a configuration provides a relatively straightforward implementation of data rate controls, allowing a minimum of control bits or fields to set the rate at which devices communicate. However, this configuration can in some instances be overly rigid.

### BRIEF SUMMARY OF THE INVENTION

In one embodiment of the invention, a network device is provided that is configured to operate on a communication network with decoupled transmit and receive data rates. The network device can include first control logic configured to announce at least one of its transmit and receive data rate parameter; second control logic configured to receive a data rate parameter from a second network device operating on the communication network; and third control logic configured to set at least one of its transmit and receive data rate based on the received data rate parameters. The data rate parameters in one embodiment can be encoded within a PHY capability bitmap octet. Particularly, in one embodiment the data rates can be encoded into an upper and lower nibble of the octet. In one embodiment network devices are configured to announce only their receive rate capability, and the second control logic determines at what rate to transmit based on the receive rate information it receives from a device to which it will be transmitting.

In another embodiment of the invention, a method is provided for selecting a data rate for communication across a communication channel, including the steps of a first network device announcing at least one of its transmit and receive data rate parameter; the first network device receiving a data rate parameter from a second network device operating on the communication network; and the first network device setting at least one of its transmit and receive data rate based on the received data rate parameters. The data rate parameters in one embodiment can be encoded within a PHY capability bitmap octet. Particularly, in one embodiment the data rates can be encoded into an upper and lower nibble of the octet. In one embodiment network devices are configured to announce only their receive rate capability, and the network device determines at what rate to transmit based on the receive rate information it receives from a device to which it will be transmitting.

In yet another embodiment of the invention, a network device is configured to operate on a communication network having decoupled transmit and receive data rates. The network device can include means for announcing at least one of its transmit and receive data rate parameter; means for receiving a data rate parameter from a second network device operating on the communication network; and means for setting at least one of its transmit and receive data rate based on the received data rate parameters. The data rate parameters in one embodiment can be encoded within a PHY capability bitmap octet. Particularly, in one embodiment the data rates can be encoded into an upper and lower nibble of the octet. In one embodiment network devices are configured to announce only their receive rate capability, and the network device determines at what rate to transmit based on the receive rate information it receives from a device to which it will be transmitting.

In a further embodiment of the invention, a computer program product comprises a computer useable medium embodying program code enabling a process for selecting a data rate for communication across a communication channel. The program code can include program code configured to cause a first network device announcing at least one of its transmit and receive data rate parameter; program code configured to cause the first network device receiving a data rate parameter from a second network device operating on the communication network; and program code configured to cause the first network device setting at least one of its transmit and receive data rate based on the received data rate parameters. The data rate parameters in one embodiment can be encoded within a PHY capability bitmap octet. Particularly, in one embodiment the data rates can be encoded into an upper and lower nibbles of the octet. In one embodiment network devices are configured to announce only their receive rate capability, and the network device determines at what rate to transmit based on the receive rate information it receives from a device to which it will be transmitting.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a block diagram illustrating one possible configuration of a wireless network that can serve as an example environment in which the present invention can be implemented.

FIG. 2 is a diagram illustrating one possible configuration of a communication window that can serve as an example environment in which the present invention can be implemented.

FIG. 3 is a diagram illustrating one possible example configuration of a network device that can serve as part of an example environment in which the present invention can be implemented.

FIG. 4 is a diagram illustrating an example process for identifying transmit and receive capabilities of network devices during a scheduling window in accordance with one embodiment of the invention.

### DESCRIPTION OF THE PREFERRED EMBODIMENTS

The present invention is directed toward a system and method for providing decoupling of data rates for a communication channel. In one embodiment, the present invention provides a system and method for allowing devices to operate at different data rates for transmit and receive operations. In one embodiment, the communication channel requirements are relaxed such that transmit rates are not coupled to receive rates, or vice versa. In such embodiments, the device is free to establish the transmit or receive data rate in a manner appropriate for the communication operation or device parameters.

Before describing the invention in detail, it is useful to describe an example environment in which the invention can be implemented. One such example is a wireless beaconing network in which multiple electronic devices (for example, computers and computing devices, cellular telephones, personal digital assistants, motion and still cameras, among others) can communicate and share data, content and other information with one another. One example of such a network is that specified by the WiMedia standard (within WiMedia and Multi-Band OFDM Alliance). From time-to-time, the present invention is described herein in terms of a distributed network or in terms of the WiMedia standard. Description in terms of these environments is provided to allow the various features and embodiments of the invention to be portrayed in the context of an exemplary application. After reading this description, it will become apparent to one of ordinary skill in the art how the invention can be implemented in different and alternative environments. Indeed, applicability of the invention is not limited to a distributed wireless network, nor is it limited to the MB-UWB standard described as one implementation of the example environment.

Most network standards specify policies or rules that govern the behavior of network connected devices. The WiMedia standard specifies the mechanism and policies that are to be followed by W-USB and WiNet compliant devices in order to allow for an ad hoc and distributed network of such devices to operate efficiently. Policies, requirements, protocols, rules, guidelines or other factors used to incentivize, recommend, specify, govern, control or manage the behavior of devices operating in a communication network are generally referred to herein as utilization policies.

In most distributed networks, the network of the devices is maintained by requiring all devices to announce parameters such as their presence, their capabilities and their intentions for reserving transmission slots and so on. For example, with the WiMedia standard, this can be done during what are referred to as beacon period time slots. According to this standard, devices joining the network are expected to monitor the beacon period to learn about the network status and parameters before attempting to use the network. In other network configurations, beacon periods are similarly used to allow management of network devices as described more fully below. Thus, beacon periods are one form of window or network period during which scheduling or other housekeeping activities can be conducted. Beacon periods in the above-referenced standard, and other time periods used for scheduling or other housekeeping chores in other network configurations, are generally referred to as scheduling windows.

Devices are typically allowed to enter a power save mode to conserve power and possibly prolong operation. For example, battery operated devices may enter a sleep mode or even a deep-sleep mode, wherein one or more of their functions are diminished or shut down in order to conserve power. Depending on the environment, devices may be allowed to enter into a sleep mode for short or long periods of time. For example, a sleep mode can be an energy-saving mode of operation in which some or all components are shut down or their operation limited. Many battery-operated devices, such as notebook computers, cell phones, and other portable electronic devices support one or more levels of a sleep mode. For example, when a notebook computer goes into one level of sleep mode, it may turn off the hard drive and still allow the user to perform operations, only powering up the hard drive when access is needed. In a deeper level of sleep, the computer may further turn off the display. In yet a further level of sleep, the computer may enter a hibernate state. Likewise, other electronic devices communicating across a communication channel may have similar sleep states and may power down unnecessary or unused components, including an RF transceiver, depending on a number of factors such as elapsed time, activities and so on. As described below, in accordance with one embodiment, devices may be prompted to enter a sleep mode upon completion of scheduling or other housekeeping activities and be configured to awaken for scheduled activities such as, for example, communication activities.

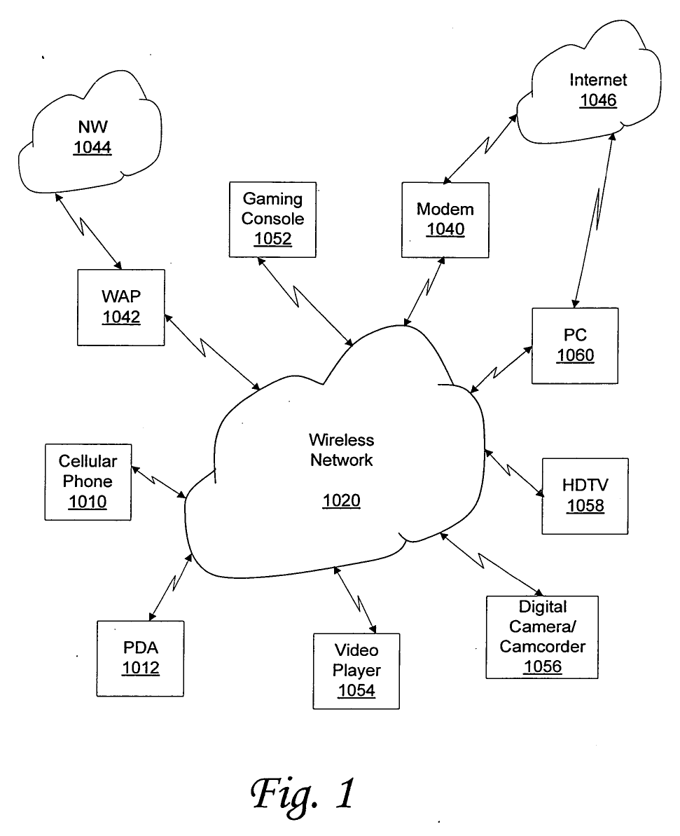

FIG. 1 is a block diagram illustrating one possible configuration of a wireless network that can serve as an example environment in which the present invention can be implemented. Referring now to FIG. 1, a wireless network 1020 is provided to allow a plurality of electronic devices to communicate with one another without the need for wires or cables between the devices. A wireless network 1020 can vary in coverage area depending on a number of factors or parameters including, for example, the transmit power levels and receive sensitivities of the various electronic devices associated with the network. Examples of wireless networks can include the various IEEE and other standards as described above, as well as other wireless network implementations.

With many applications, the wireless network 1020 operates in a relatively confined area, such as, for example, a home or an office. The example illustrated in FIG. 1 is an example of an implementation such as that which may be found in a home or small office environment. Of course wireless communication networks and communication networks in general are found in many environments outside the home and office as well. In the example illustrated in FIG. 1, wireless network 1020 includes a communication device to allow it to communicate with external networks. More particularly, in the illustrated example, wireless network 1020 includes a modem 1040 to provide connectivity to an external network such as the Internet 1046, and a wireless access point 1042 that can provide external connectivity to another network 1044.

Also illustrated in the example wireless network 1020 are portable electronic devices such as a cellular telephone 1010 and a personal digital assistant (PDA) 1012. Like the other electronic devices illustrated in FIG. 1, cellular telephone 1010 and PDA 1012 can communicate with wireless network 1020 via the appropriate wireless interface. Additionally, these devices may be configured to further communicate with an external network. For example, cellular telephone 1010 is typically configured to communicate with a wide area wireless network by way of a base station.

Additionally, the example environment illustrated in FIG. 1 also includes examples of home entertainment devices connected to wireless network 1020. In the illustrated example, electronic devices such as a gaming console 1052, a video player 1054, a digital camera/camcorder 1056, and a high definition television 1058 are illustrated as being interconnected via wireless network 1020. For example, a digital camera or camcorder 1056 can be utilized by a user to capture one or more still picture or motion video images. The captured images can be stored in a local memory or storage device associated with digital camera or camcorder 1056 and ultimately communicated to another electronic device via wireless network 1020. For example, the user may wish to provide a digital video stream to a high definition television set 1058 associated with wireless network 1020. As another example, the user may wish to upload one or more images from digital camera 1056 to his or her personal computer 1060 or to the Internet 1046. This can be accomplished by wireless network 1020. Of course, wireless network 1020 can be utilized to provide data, content, and other information sharing on a peer-to-peer or other basis, as the provided examples serve to illustrate.

Also illustrated is a personal computer 1060 or other computing device connected to wireless network 1020 via a wireless air interface. As depicted in the illustrated example, personal computer 1060 can also provide connectivity to an external network such as the Internet 1046.

In the illustrated example, wireless network 1020 is implemented so as to provide wireless connectivity to the various electronic devices associated therewith. Wireless network 1020 allows these devices to share data, content, and other information with one another across wireless network 1020. Typically, in such an environment, the electronic devices would have the appropriate transmitter, receiver, or transceiver to allow communication via the air interface with other devices associated with wireless network 1020. These electronic devices may conform to one or more appropriate wireless standards and, in fact, multiple standards may be in play within a given neighborhood. Electronic devices associated with the network typically also have control logic configured to manage communications across the network and to manage the operational functionality of the electronic device. Such control logic can be implemented using hardware, software, or a combination thereof. For example, one or more processors, ASICs, PLAs, and other logic devices or components can be included with the device to implement the desired features and functionality. Additionally, memory or other data and information storage capacity can be included to facilitate operation of the device and communication across the network. Software can include program code that is executable by a processing device to perform the desired functions.

Electronic devices operating as a part of wireless network 1020 are sometimes referred to herein as network devices, members or member devices of the network or devices associated with the network. In one embodiment devices that communicate with a given network may be members or merely in communication with the network.

Some communication networks are divided into periods or frames that can be used for communication and other activities. For example, as discussed above, some networks have a scheduling window such as, for example, a beacon period, for scheduling upcoming communication activities. Also, some networks have a communication window during which such communication activities take place. In the WiMedia-MBOA standard, the bandwidth is divided into superframes, which in turn are divided into time slots for the transmission and reception of data by the various electronic devices associated with the network.

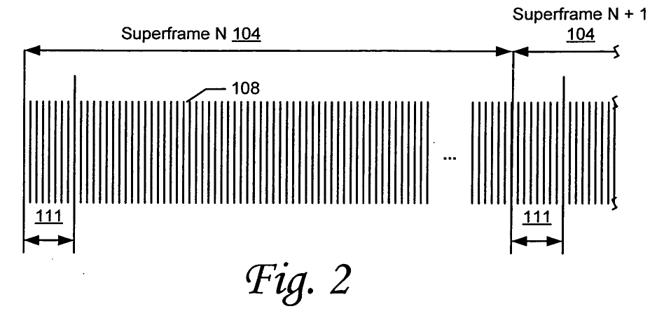

An example of such time slots are illustrated in FIG. 2. Referring now to FIG. 2, in this exemplary environment, the communication bandwidth is divided into superframes 104 (two illustrated), each superframe 104 itself being divided into a plurality of timeslots referred to as Media Access Slots 108. In the example environment, there are 256 media access slots 108 in each superframe 104, although other allocations are possible. Additionally, at the beginning of each superframe 104 is a beacon period 111, which is comprised of a plurality of beaconing slots. In some networks, the beacon period 111 is a period during which devices reserve timeslots and exchange other housekeeping or status information. For example, in the WiMedia-MBOA distributed wireless network, the superframes comprise a beacon period 111, during which devices are awake and receive beacons from other devices. Superframes in the above-referenced standard, and other time periods used for communications among devices in other network configurations, with or without scheduling windows, are generally referred to herein as communication windows. As noted above, for clarity of description the present invention is described in terms of the example environment, and thus is at times described using the terms superframe and beacon period. As would be apparent to one of ordinary skill in the art after reading this description, the invention applies to other communication formats, including the more general case utilizing scheduling windows and communication windows. Additionally, the invention is not limited to applications where the bandwidth is divided into frames or windows, but can be generally applied to communication channels and networks of various protocols and configurations.

Network devices can take on various configurations and architectures and, as the above examples illustrate, can perform a variety of functions, from printers, to web cameras, to modems, to servers, and so on. Network devices typically have some form of control logic that is configured to manage communications across the network and to manage the operational functionality of the network device. Such control logic can be implemented using hardware, software, or a combination thereof. For example, one or more processors, ASICs, PLAs, and other logic devices or components can be included with the device to implement the desired features and functionality. Additionally, memory or other data and information storage capacity can be included to facilitate operation of the device and communication across the network.

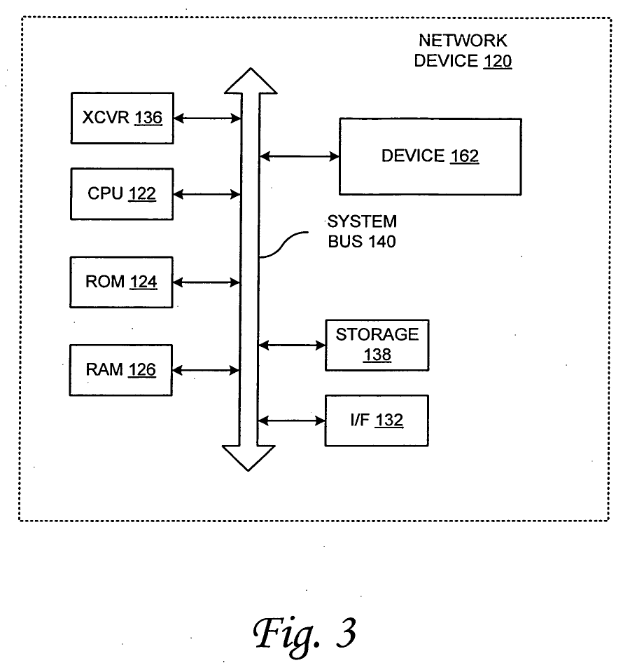

One example configuration of a network device that can be used with a wireless network is illustrated in FIG. 3. Referring now to FIG. 3, the example network device 120 includes a CPU 122, ROM 124, RAM 126, and a system bus 140. The CPU operates to execute program code that would typically be stored, for example, in ROM 124, and generally controls the functionality for the network device. RAM 126 can be included to serve as working memory for processor operations and other storage. Although not illustrated, removable memory can also be provided.

For external communications, the network device can also include communications capabilities. For instance, the example illustrated in FIG. 3 includes a wireless transceiver 136 and an external interface 132. As a practical example, in the case of a cellular telephone, the device 120 could include a wireless transceiver 136 for cellular communications and external interface 132 could, for example be a Bluetooth® interface, docking port, or other local communication interface.

Device 162 is a black-box representation of the functionality that can be performed by the network device 120. For example, in the case of a web camera, device 162 can include imaging optics, an image sensor, image buffers, and other like functionality. Device 162 can include dedicated processing and memory capabilities, or can use CPU 122, ROM 124, and RAM 126 for some or all of its operation.

Network device 120 may further include secondary storage devices 138, such as but not limited to hard drives, floppy drives, CD and DVD ROM and RWM drives, removable memory or storage devices, or other computer program product interfaces and associated computer program products. Computer program product interfaces can include, for example, devices that access objects (such as information, data, software, and other program code) embodied in computer program products, whether internally or externally to network device 120. Examples of computer program product interfaces can include, for example, hard drives, floppy drives, removable drives, optical storage devices, card slots, wireless or wired communication interfaces, communication ports, and so on. Examples of computer program products include, but are not limited to, disks, memory cards and any other media compatible with the various interfaces. Computer program products can also include signals or other media that transport the computer program code to the device. Thus, the term “computer program product” is not limited to a particular device, but instead generally refers to any device or media in or through which program code is made available to the network device.

Having thus described an example environment in which the invention can be implemented, various features and embodiments of the invention are now described in further detail. Description may be provided in terms of this example environment for ease of discussion and understanding only. After reading the description herein, it will become apparent to one of ordinary skill in the art that the present invention can be implemented in any of a number of different communication environments (including wired or wireless communication environments, and distributed or non-distributed networks) operating with any of a number of different electronic devices and according to various similar or alternative protocols or specifications.

Many networks and communication channels specify that network devices perform transmit operations at the same data rates as receive operations. As one example, at the time of this invention, the specified versions of the MB-OFDM (WiMedia) system define device physical layer capabilities in terms of symmetrical support of all data rates. In this definition both transmit and receive data rate capabilities are associated with a single bit in the PHY Capability Bitmap field. As the current definition of this standard consists of eight data rates, and an entire eight-bit byte (octet) is utilized to define the device capability. As such, the data rates are coupled, in that transmit and receive operations take place at the same data rate. The current definition has two shortcomings, including the requirement that each device support a particular data rate for transmission and reception, and the association of each data rate with a single bit. Furthermore, transmitting all those bits over the air lowers the bandwidth utilization and capacity of the system.

Because network devices are often targeted for cost and power sensitive applications, it is desirable to avoid adding unnecessary complexity. This is especially true for wireless network devices seeking to attain higher performance at lower levels of power consumption. Many network and other communication devices and applications do not require or would not benefit from symmetrical data rates for transmit and receive. Some of these devices may include, for example, web cameras, printers, and so on. For instance, consider a typical web camera device. Such devices capture large amounts of image data and in order to be effective may be required to transmit this captured image data at relatively high data rates. These cameras, however, typically only receive small amounts of control data. Therefore, a web camera may actually utilize a lower (sometimes significantly lower) data rate to receive any necessary or desirable control information. Similarly, with a printing device, high data rates may from time to time be used to receive the information to be printed, while a much lower data rate is needed to return status and control information from the printer to the requesting device.

However, if a device is constrained to the same data rate for transmit and receive operations (i.e., symmetrical data rates), performance is typically impacted if that data rate is chosen at the lower of the two rates. For example, consider how long it would take to transfer image data from a web camera to a server if its data rate were constrained to the rate necessary to send control information to the camera. Therefore, such symmetrical devices are implemented in conventional solutions with both the transmit and receive rates specified at the higher of the two rates. However, complexity of the transmit or receive sections of the device may be unnecessarily increased if requirements constrain both the transmit and receive operations to the higher of the two rates.

The complexity of the device is often directly related to the device cost. For example, utilizing increased data rates can lead to a need for increased size or performance of the logic or other componentry utilized to implement the processing and communication functions. Additionally, increased data rates can also lead to increased power consumption. As such, devices that are implemented in accordance with specifications in MB-OFDM (WiMedia) for symmetrical data rates will likely have a higher cost and greater power consumption associated therewith.

One embodiment of the present invention permits a decoupling of the transmit and receive data rates for devices. This can be implemented so as to allow reduced complexity for one of the transmit or the receive chain relative to the other. In other words, in the example of the camera, the receive componentry (e.g., hardware, software, and/or firmware) that receives the lower data rate control information can be implemented in a less complex manner. Preferably, this can lead to a lower cost and a lower power-consumption implementation than would otherwise be obtainable were that receiver implemented to operate at the higher data rate.

In accordance with another embodiment, of the invention, decoupling of the data rates can be implemented without added unnecessary overhead to the network controls. For example, in term of the example environment, the device transmit and receive data rate capabilities can be encoded within existing PHY Capability Bitmap octet using, for example, the upper and lower nibbles, respectively (or vice versa).

As set forth in section 7.8.15, of the WiMedia (MBOA) specification, the PHY Capability Bitmap field comprises two octets, one defining the data rates and the other the band groups. There are eight data rates defined within the WIMEDIA (MBOA) specification Capability Bitmap field. In one embodiment, data rates for transmit and receive must be the same, and each bit of this field identifies a single data rate. According to an embodiment of the invention, the structure of PHY Capabilities IE can be implemented as illustrated in Table 1.

TABLE 1

| Octets: 1 | 1 | 2 | x |
|---|---|---|---|
| Element ID | Length(=2 + x) | PHY Capability | |

| | |
|---|---|
| Data Rate | Band Group |

The Data Rate octet of the PHY Capability field can be further divided in one embodiment into the upper and lower nibbles of the octet as shown in Table 2.

TABLE 2
Data Rates

| b7-b4 | b3-b0 |
|---|---|
| Tx Rates | Rx Rates |

Each nibble being four bits in length can encode a set of up to 16 data rates. The data rates specified for the upper and lower nibbles can be defined the same set of rates (as illustrated below), different rates depending on the nibble, or a hybrid of these two approaches. In one embodiment, the encoding of the four bits are the same for each nibble, such that a given codeword encodes the same data rate for both nibbles. As a specific example, the encoding for each nibble of the data rate octet can be implemented as illustrated in Table 3. As these examples illustrated, the invention can be implemented in such a way as to provide flexibility in assigning or identifying data rates for transmit and receive operations for a given application.

TABLE 3
Data Rates Encoding

| | | |
|---|---|---|
| 0000 | 53.3 | Mbps |
| 0001 | 80 | Mbps |
| 0010 | 106.7 | Mbps |
| 0011 | 160 | Mbps |
| 0100 | 200 | Mbps |
| 0101 | 320 | Mbps |
| 0110 | 400 | Mbps |
| 0111 | 480 | Mbps |

| | |
|---|---|
| 1000 to | Reserved |
| 1111 | |

In one embodiment, all data rates up to the maximum rate indicated by the device can be supported. In this embodiment, unused data rate codewords can be utilized for future extensions of data rates. For instance, in the example illustrated in Table 3, codewords 1000 to 1111 are reserved for future use.

In an alternative embodiment, however, not all of the data rates up to the device maximum are supported. Unsupported data rates, or rate holes, can be indicated by the codeword. For example, for unsupported data rates the most significant bit of the codeword associated with the next higher data rate can be set to a ‘1.’ Alternative configurations can be used to indicate unsupported data rates. Additionally, in yet another embodiment, two bytes can be used to define the transmit and receive data rate capabilities without encoding.

In one embodiment of the invention, the receive and transmit capabilities of one or more network devices can be identified during a scheduling window such as, for example, during a Beacon period 111, or during some other initialization period. This can be accomplished in one embodiment through the use of an un-coded (for example, bitfield) mapping of octets. In one embodiment this can be accomplished by mapping two separate octets (bytes), one for receive and one for transmit.

In a further embodiment, the transmit and receive data rates can be decoupled by designating the rate capability of each device for only one of either its transmitter or receiver. For example, in one embodiment, the rate capability of network device receivers is designated, and the devices' transmit rate capabilities are not announced. The transmit rate capability is known to the transmitting device, while the receive rate capability of the receiving device is announced through its beacon 111 or other scheduling window. Hence, the transmitting device can determine at what data rate to transmit based on the information it receives during the beacon period 111. This would decouple the receive and transmit rate capability implicitly.

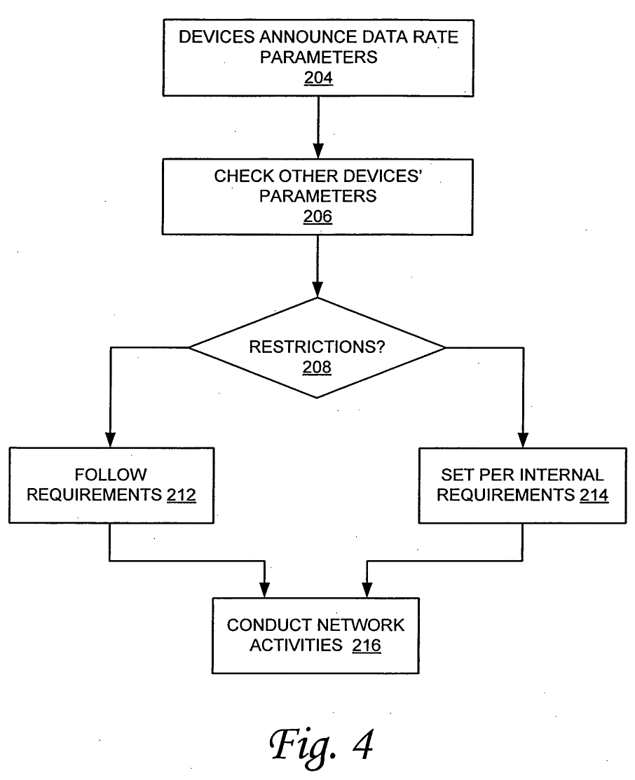

FIG. 4 is a diagram illustrating an example process for identifying transmit and receive capabilities of network devices during a scheduling window in accordance with one embodiment of the invention. Referring now to FIG. 4, in a step 204, network devices announce their data rate requirements or other parameters. In one embodiment, each device associated with the network announces its transmit and receive data rate parameters. In another embodiment, only network devices having particular parameter requirements announce their parameters. In yet another embodiment all devices announce either the transmit requirements or the receive requirements, as noted above.

In a step 206, the network devices check the data rate parameters announced by the other network devices. In one embodiment, this can be performed by each device operating on the network. In other embodiments this can be done selectively. If a network device has particular requirements, the device with which it is communicating can note those requirements in step 206, and then follow those requirements as indicated by steps 208 and 212. Otherwise, the device may make an independent decision regarding its operating rates as indicated by steps 208 and 214. In a step 216, with rates set, the devices can conduct network activities.

To better illustrate the above methodology it is useful to consider a simple example. For example, consider a web camera that may require a very high transmit rate to download image data, yet a relatively low data rate to receive control information. Further consider that the camera is communicating with a video recorder/playback device that has a high data rate for both transmit and receive operations, a monitor that has a high data rate for receive operations and a low data rate for transmitting status information, and a server that has full flexibility in rate setting. In an embodiment where devices disclose their receive requirements only, the camera would disclose its low rate capabilities, the video recorder could announce a desired high receive rate as could the monitor and the server. Thus, devices communicating information to the camera would know that they need to use the camera's lower receive rate for their transmit operations, and could continue to receive information at the higher data rate.

While various embodiments of the present invention have been described above, it should be understood that they have been presented by way of example only, and not of limitation. Thus the breadth and scope of the present invention should not be limited by any of the above-described exemplary embodiments. Additionally, the invention is described above in terms of various exemplary embodiments and implementations. It should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A network device configured to operate on a communication network having decoupled transmit and receive data rates, the network device comprising:
first control logic configured to announce at least one of its transmit and receive data rate parameter;
second control logic configured to receive a data rate parameter from a second network device operating on the communication network; and
third control logic configured to set at least one of its transmit and receive data rate based on the received data rate parameters.

2. The network device of claim 1, wherein data rate parameters for a network device are encoded within a physical layer bitmap octet.

3. The network device of claim 2, wherein data rates are encoded into at least one of the upper and lower nibbles of the octet.

4. The network device of claim 3, wherein a codeword for one nibble of the octet identifies the same data rate as that identified by the same codeword in the other nibble of the octet.

5. The network device of claim 2, wherein data rates are encoded as
Data Rates Encoding

| | | |
|---|---|---|
| 0000 | 53.3 | Mbps |
| 0001 | 80 | Mbps |
| 0010 | 106.7 | Mbps |
| 0011 | 160 | Mbps |
| 0100 | 200 | Mbps |
| 0101 | 320 | Mbps |
| 0110 | 400 | Mbps |
| 0111 | 480 | Mbps |
| | |
|---|---|
| 1000 to | Reserved |
| 1111 | |

6. The network device of claim 2, wherein data rates are encoded into the upper and lower nibbles of the octet as follows
Octet

| b7-b4 | b3-b0 |
|---|---|
| Tx Rates | Rx Rates |

7. The network device of claim 1, wherein the first control logic is configured to announce the data rate parameter during a scheduling window.

8. The network device of claim 7, wherein the scheduling window is a beacon period.

9. The network device of claim 1, wherein each network device operating on the communication network is configured to announce only its receive rate capability, and the second control logic determines at what rate to transmit based on the receive rate information it receives from a device to which it will be transmitting.

10. The network device of claim 1, wherein each network device operating on the communication network is configured to announce only its transmit rate capability, and the second control logic determines at what rate to receive based on the receive rate information it receives from a device from which it will be receiving.

11. A method for selecting a data rate for communication across a communication channel, the method comprising the steps of:
a first network device announcing at least one of its transmit and receive data rate parameter;
the first network device receiving a data rate parameter from a second network device operating on the communication network; and
the first network device setting at least one of its transmit and receive data rate based on the received data rate parameters.

12. The method of claim 11, wherein data rate parameters for a network device are encoded within a physical layer capability bitmap octet.

13. The method of claim 12, wherein data rates are encoded into at least one of the upper and lower nibbles of the octet.

14. The method of claim 13, wherein a codeword for one nibble of the octet identifies the same data rate as that identified by the same codeword in the other nibble of the octet.

15. The method of claim 12, wherein data rates are encoded as
Data Rates Encoding

| | | |
|---|---|---|
| 0000 | 53.3 | Mbps |
| 0001 | 80 | Mbps |
| 0010 | 106.7 | Mbps |
| 0011 | 160 | Mbps |
| 0100 | 200 | Mbps |
| 0101 | 320 | Mbps |
| 0110 | 400 | Mbps |
| 0111 | 480 | Mbps |
| | |
|---|---|
| 1000 to | Reserved |
| 1111 | |

16. The method of claim 12, wherein data rates are encoded into the upper and lower nibbles of the octet as follows
Octet

| b7-b4 | b3-b0 |
|---|---|
| Tx Rates | Rx Rates |

17. The method of claim 11, wherein the first control logic is configured to announce the data rate parameter during a scheduling window.

18. The network device of claim 17, wherein the scheduling window is a beacon period.

19. The method of claim 11, wherein each network device operating on the communication network announces only its receive rate capability, and further comprising a step of the first network device determining at what rate to transmit based on the information it received from a device to which it will be transmitting.

20. The method of claim 11, wherein each network device operating on the communication network announces only its transmit rate capability, and further comprising a step of the first network device determining at what rate to receive based on information it receives from a device from which it will be receiving data.

21. A network device configured to operate on a communication network having decoupled transmit and receive data rates, the network device comprising:
means for announcing at least one of its transmit and receive data rate parameter;
means for receiving a data rate parameter from a second network device operating on the communication network; and
means for setting at least one of its transmit and receive data rate based on the received data rate parameters.

22. A computer program product comprising a computer useable medium embodying program code enabling a process for selecting a data rate for communication across a communication channel, the program code comprising:
program code configured to cause a first network device announcing at least one of its transmit and receive data rate parameter;
program code configured to cause the first network device receiving a data rate parameter from a second network device operating on the communication network; and
program code configured to cause the first network device setting at least one of its transmit and receive data rate based on the received data rate parameters.

23. The computer program product of claim 22, wherein data rate parameters for a network device are encoded within a physical layer capability bitmap octet.

24. The computer program product of claim 23, wherein data rates are encoded into at least one of the upper and lower nibble of the octet.

25. The computer program product of claim 24, wherein a codeword for one nibble of the octet identifies the same data rate as that identified by the same codeword in the other nibble of the octet.

26. The computer program product of claim 23, wherein data rates are encoded as
Data Rates Encoding

| | | |
|---|---|---|
| 0000 | 53.3 | Mbps |
| 0001 | 80 | Mbps |
| 0010 | 106.7 | Mbps |
| 0011 | 160 | Mbps |
| 0100 | 200 | Mbps |
| 0101 | 320 | Mbps |
| 0110 | 400 | Mbps |
| 0111 | 480 | Mbps |
| | |
|---|---|
| 1000 to | Reserved |
| 1111 | |

27. The computer program product of claim 23, wherein data rates are encoded into the upper and lower nibbles of the octet as follows
Octet

| b7-b4 | b3-b0 |
|---|---|
| Tx Rates | Rx Rates |

28. The computer program product of claim 22, wherein the first control logic is configured to announce the data rate parameter during a scheduling window.

29. The computer program product of claim 28, wherein the scheduling window is a beacon period.

30. The computer program product of claim 22, wherein each network device operating on the communication network announces only its receive rate capability, and further comprising a step of the first network device determining at what rate to transmit based on the information it received from a device to which it will be transmitting.

31. The computer program product of claim 22, wherein each network device operating on the communication network announces only its transmit rate capability, and further comprising a step of the first network device determining at what rate to receive based on the information it received from a device from which it will be receiving.

32. A network device configured to operate on a WiMedia-MBOA communication network, the network device comprising:
first control logic configured to determine a transmit data rate for network communications;
second control logic configured to determine a receive data rate for network communications; and
wherein said transmit and receive data rates are different data rates.

33. A method for selecting a data rate for communication across a WiMedia-MBOA communication network, the method comprising the steps of:
a first network device determining a transmit data rate for network communications;
the first network device determining receiving a receive data rate for network communications;
wherein said transmit and receive data rates are different data rates.
